(19) United States
(12) Patent Application Publication
(10) Pub. No.: US 2007/0143146 A1
(43) Pub. Date: Jun. 21, 2007

(54) Method and information system for performing a clinical study on a patient

(76) Inventors: Klaus Abraham-Fuchs, Erlaangen (DE); Eva Rumpel, Erlangen (DE); Markus Schmidt, Nurnberg (DE); Siegfried Schneider, Erlangen (DE); Horst Schreiner, Furth (DE); Gudrun Zahlmann, Neumarket (DE)

Correspondence Address: HARNESS, DICKEY & PIERCE, P.L.C., P.O.BOX 8910, RESTON, VA, 20195, US

(21) Appl. No.: 10/589,560

(22) PCT Filed: Feb. 9, 2005
(86) PCT No.: PCT/EP05/50553

§ 371 Date: Aug. 16, 2006

(30) Foreign Application Priority Data
Feb. 18, 2004 (DE) 10 2004 008 194.8
Oct. 28, 2004 (DE) 10 2004 052 473.4

(51) Int. Cl. G06Q 50/00

(52) U.S. Cl. 705/3

(57) ABSTRACT

A method is disclosed for performing a clinical study on a patient. The study-related or patient-related data is stored in a memory during the study. The memory is readable by a physician who is foreign to the study and is associated with the patient. An information system for a clinical study on a patient encompasses a memory for study-related or patient-related data, which is allocated to the patient, a data input device for storing data in the memory, and a data reading device for reading out the data from the memory. The data reading device is accessible to a physician who is foreign to the study and is associated with the patient.

### PRIORITY STATEMENT

This application is the national phase under 35 U.S.C. §371 of PCT International Application No. PCT/EP2005/050553 which has an International filing date of Feb. 9, 2005, which designated the United States of America and which claims priority on German Patent Application numbers 10 2004 008 194.8 filed Feb. 18, 2004 and 10 2004 052 473.4 filed Oct. 28, 2004, the entire contents of which are hereby incorporated herein by reference.

### FIELD

The invention generally relates to a method and/or an information system for carrying out a clinical study on a patient.

### BACKGROUND

Clinical studies are commissioned and carried out by various backers or sponsors such as pharmaceutical companies, clinics or state institutions. For example, new medicaments, methods for surgical intervention, therapies or diagnostic devices are tested on patients. The aim is often approval of the tested product before an approval authority.

A special study doctor who frequently sees the patient throughout the course of the study, usually in a clinic, is responsible for carrying out the study on a patient. There are rules worked out to the smallest detail to which the study doctor must adhere, the so-called study protocol, for carrying out the study. The study doctor receives the patient, for example regularly at prescribed intervals. In the ideal case, they consult with them for all health issues, i.e. including those which are not related to the study. For example, the study doctor carries out control examinations, tests or interviews on the patient, in order to document the properties or mode of action of the medicament etc. studied in the study, or else to monitor the patient's general health condition. The results determined in this way are incorporated into the study as study data.

Particularly for studies which relate to new medicaments, newly developed active agents or active agent combinations are usually administered to the patient. This is done during various development phases of the medicament. The study doctor is fully informed about the study, i.e. for example they know the precise chemical composition of the new active agents or the properties of a particular therapy and its interactions with known medicaments or diagnostic and treatment methods. The study doctor can thus adapt their entire treatment of the patient as regards examination methods, therapies, medication etc. to the study and all interactions with the patient.

This is important above all for particular occurrences, for example an incidental disease of the patient which is not related to the study, and which requires an interaction of the study doctor with the patient which is not covered by the study protocol. Here, the study doctor must take their knowledge about the study into account in their diagnosis and treatment, for example so as not to endanger the patient by mutually incompatible active agents, i.e. interactions between new and existing medicaments. They can also select their examination or treatment methods as far as possible so that they do not affect the study, or even make the patient unsuitable for further participation in the study.

An interaction of the patient with a doctor who is not personally involved as someone responsible for the clinical study, and is not therefore informed about the study, is problematic. Such a doctor is, for example, the patient's usual family doctor or an emergency doctor who treats the patient in an accident situation. This is because owing to their participation in the study, the patient may exhibit modified reactions to treatments which are generally standard or indicated in a particular situation, or modified measurement values may be taken from them. For example, the patient may exhibit a modified blood count or modified blood pressure or pulse values, which are harmless in the scope of the clinical study but which an uninformed doctor would regard as cause for concern. A doctor not informed about the study could thus be led to a misdiagnosis or mistreatment of the patient.

Problems exist not only for the patient, whose health might suffer, but also for the backer or sponsor of the study since an examination or treatment of the patient which is incompatible with the study could mean that they have to be excluded from the study. The success or quality of the clinical study in turn depends on this, and often significant financial investment or losses for the backer or sponsor often depend thereon.

For this reason, a patient in a clinical study has previously been provided with a multiplicity of documents which contain as detailed as possible a description of the medical study. The patient has been obliged to inform a non-study doctor, who is interacting with them, about the study and let them see the documents. Previously, therefore, patients participating in a clinical study have needed to take all the relevant documents about the current study with them and present them to the treating doctor.

The non-study doctor has had to study and evaluate the documents provided to them, and possibly communicate with those responsible for the study in order to obtain certain further information about the relevant patient or the study. For example, the precise composition of a new active agent is generally intended to be kept secret and is not therefore known in the documents with which the patient is provided, but must be released to the treating doctor in a health-risk situation for the patient.

In paper form or in the form of X-ray recordings, for example, the study documents carried with them by the patient are extensive and bulky, often unstructured and therefore difficult or quite onerous for the non-study doctor to study, or difficult for the patient to transport because of their volume. Even with a planned visit to a non-study doctor, patients often neglect or omit to carry the documents with them owing to circumstances.

Only in the rarest of cases, furthermore, are the documents permanently carried with them by the patient. A situation in which they consult a non-study doctor without warning, for example because of an emergency, can therefore be problematic for the patient, above all if the patient is not conscious and therefore cannot verbally inform the doctor about the study participation. To this end, in the past the patient has usually carried an indication or note with them, for example in their purse, on which the clinical study would be specified or a contact address would be given, for example a telephone number of someone responsible for the study or the like. The treating doctor would then first have to learn about the study, for example by a telephone call, before they could treat the patient optimally.

### SUMMARY

A method, in at least one embodiment, is provided for better informing a non-study doctor about a clinical study being carried out on their patient. An information system, in at least one embodiment, is also provided, operating by the method.

With respect to the method, the object is achieved according to the invention by a method for carrying out a clinical study on a patient, wherein study- or patient-related data are stored in a memory during the clinical study, the data being readable from the memory by a non-study doctor assigned to the patient.

Study- or patient-related data are, for example, all the data about the study known in the scope of the clinical study, medical knowledge on which the study is based, data about the study participant or the persons responsible for the study, contact addresses, background information or data about all patients or a special patient, or their health condition, as well as X-ray images, ECG charts, blood pressure tables or the like in storable, i.e. usually digitized form. All data relating to a patient or the study, which seem worth communicating in any way to a non-study doctor who comes in contact with, treats or examines the patient, i.e. interacts with them and is assigned to them in this sense, may be envisaged. Since the data stored in a memory can be read out by the non-study doctor, they can evaluate them as information in order to examine and treat their patient as far as possible in accord with the clinical study.

A multiplicity of different data media may be envisaged as memories, for example diskettes, magnetic tapes, (rewritable) CD-ROMs or memory chips. The memory may already be present in devices or specially extended, supplemented for the purpose of the clinical study, for example a USB stick, mobile telephone or health card, optionally with memory extensions specially upgraded for the study.

The information is read out from the data medium by customary methods/devices, for example via a PC with a diskette drive or CD-ROM drive, a memory card reader or the like.

By constantly adding or deleting data in the memory, its overall content can be kept constantly up to date. In the course of the study of the patient, for example, a new X-ray image may be appended or a previously existing X-ray image may be replaced, medicaments administered to the patient may be entered, a temperature chart may be filled out or observations by the treating doctor may be added in text form.

The data in the memory can be easily supplemented, modified or checked by readout in the scope of the clinical study, which is difficult for printed documents.

The patient is obviated as a conveyor of the information; they do not have to communicate any information about the study being carried out on them personally to a non-study doctor. Specialist contexts, important information etc. are thus communicated with technical accuracy. Since the information in the form of data can now be stored in the memory so that it is technically correct, clear and comprehensible, this provides a data channel for information communication between specialist personnel or doctors. The patient, who does not personally have any write access to the data, cannot add or remove the data intentionally or inadvertently.

It is substantially easier for the patient to carry a data medium with them than to carry comprehensive paper material with them. A preselection may be made as to which information about a particular patient is important for a non-study doctor, so that little data have to be stored in the memory. The non-study doctor need not personally decide first which information might be important for them, and is informed more rapidly. Since the data in the memory are always accessible, a non-study doctor immediately has access to the data and, for example, need not first make a telephone call to someone responsible for the study.

All the information relevant for the non-study doctor is in the form of data at a single location, for example in a single file, and is not distributed over many written documents, X-ray images, loose pages, additional material or the like. It can be stored in a structured and ordered way and searched through automatically.

The data may be stored in the memory by specialist personnel involved in the study, for example, such as the study doctor treating the patient or data systems connected with the study, for example a study management system.

If the study doctor assigned to the patient, who is optimally informed both about the study and about the patient, stores the data in the memory, this ensures that the data in the memory are always up to date and only the data relating to this special patient are stored in the memory. At any time when a non-study doctor reads the data out from the memory, these are therefore up to date and complete.

If the non-study doctor reads the data out from the memory immediately before an interaction with the patient, then they can incorporate all information relevant in the scope of the study into their considerations directly at the start of their interaction i.e. a conversation, examination, diagnosis or treatment. This also ensures that the available data actually most current for the study and the patient are read by the non-study doctor, and the non-study doctor is therefore informed with the most current data. The non-study doctor is therefore informed about the study at the best possible time.

When the data are stored in the memory with standardized structuring, this provides advantages both for those responsible for the study and for the non-study doctor: for example, if the scope of the structuring provides that a wide variety of data fields have to be filled in for the data input into the memory, then no information to be stored can be forgotten on the part of those responsible for the study. If the structuring is standardized, i.e. uniform for different patients and studies, then the non-study doctor only has to learn the structuring of the data once. When reading data out from the memory for any patient of any study, they are then immediately capable of searching effectively and expediently at the correct place for data relevant to them. If they wish to administer a medicament, for example, they can look under a heading “allowed or prohibited medicaments” to find whether they may actually prescribe the medicament.

A non-study doctor can be informed particularly rapidly and simply when the data are stored in the form of clear instructions to the non-study doctor. Instructions may, for example be: “Patient must not be X-rayed”, “medicament A must not be stopped” or “the maximum dosage for medicament B is X mg/day”. The non-study doctor does not therefore first need to read into the background of the study, but instead rapidly obtains clear information. The workload and time outlay for a non-study doctor is therefore limited.

If the information is stored in the form of generally comprehensible text on the data medium, then it is particularly easy for the treating doctor to incorporate the information into their diagnosis or therapy. Less medically trained personnel, for example orderlies at an accident site or hospital personnel, receptionists, thus obtain information concerning the patient and the medical study in case of need. This may also include information about examinations, measurements which must not be carried out on the patient or absolutely should be carried out.

It is particularly favorable to introduce a standardized medical ontology for the standardized description of clinical study data. Any doctor is therefore constantly informed accurately and consistently about a clinical study. In contrast to free text formulations, misunderstandings can thus be avoided.

The data to be stored in the memory may be assigned to various classes, in which case the non-study doctor reads only information of one class out from the memory. A possible classification might for example be 1.) information which must be read by all doctors interacting with the patient, 2.) information which is of interest only to special doctors, 3.) information which is subject to privacy and should not be read under normal circumstances, but may be read for example in a life-threatening emergency. It is also possible to store on the memory, for example, which information is to be classed as confidential or which information of the study has already been published, or will be soon be published.

The advantage of this is that the information in the form of data is already pre-sorted during storage, and is presented in a structured way for the non-study doctor. Here again any non-study doctor knows which class of information they must read, according to the type of interaction with the patient.

It is particularly favorable that the data can be called up from the memory anywhere without additional aids. For example, this may be achieved by providing the memory with a display device, for example a screen. On a mobile telephone provided with an auxiliary memory, for example, the information can be read on the screen of the mobile telephone by appropriate keystrokes. The information is thus available anywhere and at any time, for example on an accident site, without additional aids such as data cables or PCs for reading out from the memory.

With respect to the information system for a clinical study on a patient, the system includes, in at least one embodiment, a memory assigned to the patient for study- or patient-related data, a data input device for storing data in the memory, and a data reading device for reading the data out from the memory, the data reading device being accessible by a non-study doctor and the non-study doctor being assigned to the patient.

Via a memory and data reading device, the information system forms a data channel between the data input device and the non-study doctor, who is interacting with the patient. The data channel transports data or information relating to the study or the patient. Depending on the length of time between storing the data and reading the data out, it is thus possible to form a real-time or data-storing information channel. The choice of the term data input or reading device merely expresses the primary functionality, and both devices may respectively be designed to read and write on the memory.

The patient may be able to carry the memory with them. A memory which may be envisaged for this is for example a USB stick, a health card with a memory, or generally usual memory cards such as SD or CF cards. Such storage media are small and lightweight, and may even be carried permanently with them by the patient. It is also possible to use storage media which a particular patient constantly carries with them in any case, for example a USB wristwatch, a check card with a memory or the like. Even in an unforeseeable emergency, the study- or patient-related data are therefore always present and available on the patient.

In an alternative embodiment, the memory is part of a data network to which the data input and reading device can be connected. Authorization, which the patient may carry with them, is then required for access to the data. Here, for example, the memory could be a hard disk in an Internet server, the data input and reading device then being a standard Internet terminal such as a Web browser, the authorization being a Web address, user ID and a password.

The patient could furthermore carry this with them, for example in a fixed written form in their purse. Even in an emergency, a non-study doctor would thus have access to the data when the patient is not responsive and cannot communicate the password and ID. The access point may in this case be embodied either in a static form via a data or modem line or in a mobile form via W-LAN or WAP.

If the patient can carry the data reading device with them, then a non-study doctor can read the data out from the memory anywhere and at any time. Possible embodiments might be a mobile telephone with a screen, in which case the data may be stored locally on a memory chip in the mobile telephone or the mobile telephone may allow access to the remotely stored data, for example through a WAP link via a network.

### BRIEF DESCRIPTION OF THE DRAWINGS

For a further description of the invention, reference will be made to the example embodiments of the drawings in which, respectively in a schematic outline sketch:

FIG. 1 shows a flow chart for a medical study on a patient “P”by a study doctor “D”,

FIG. 2 shows a flow chart for an emergency visit by the patient “P” to a non-study doctor “H”.

### DETAILED DESCRIPTION OF THE EXAMPLE EMBODIMENTS

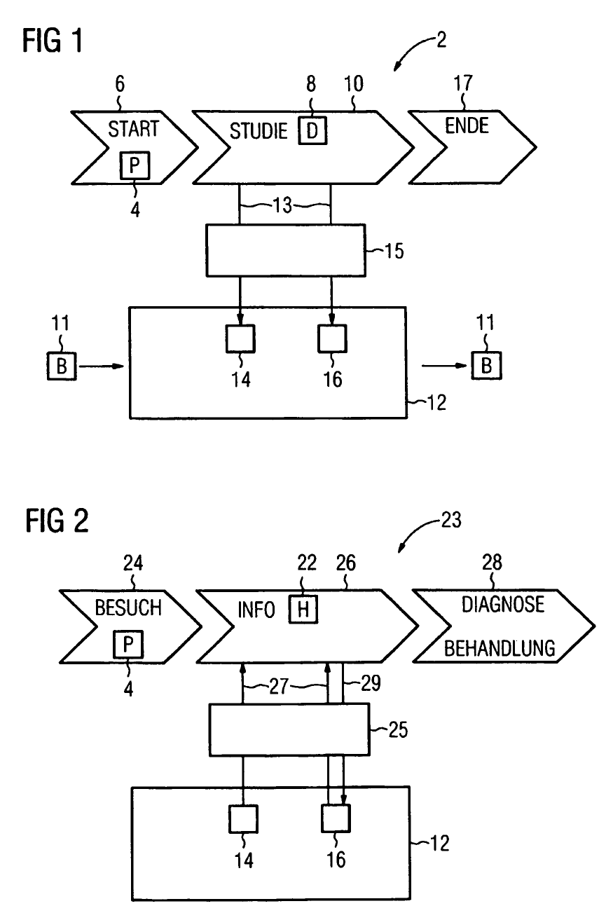

A clinical study 2 is intended to examine a new blood pressure reducing formulation from the pharmaceutical company “A-Pharma” with an active agent “ABC” in clinical phase III of a state approval procedure. To this end, 500 suitable patients are selected and the blood pressure reducing formulation is administered to them for one year. FIG. 1 shows the entire time profile of the clinical study 2 on an individual patient “P” 4 from left to right in chronological order.

The patient 4 begins the one-year participation in the study 2 at 1.1.2000 in a start step 6. The patient 4 is assigned a study doctor “D” 8 for the duration of the study 2. They are responsible for the patient 4 and represent a contact or doctor for them in all study-relevant questions and events.

In the course of the year, the patient 4 therefore visits the study doctor 8 monthly. This is represented as a recurring study step 10 in FIG. 1. At each study step 10, the study doctor 8 examines the patient 4 and measures their blood pressure, pulse and blood values. They furthermore note the overall impression which they have of the patient 4. In the scope of the study 2, the patient 4 is instructed to see their study doctor 8 on the 15th of each month.

At the beginning of the study 2, the study doctor 8 receives a memory 12 in the form of a USB wristwatch for the patient 4 from the study leader “B” 11. All study data 14 (see below) relating to the study 2 in general, but not to the patient 4 in particular, have already been stored on this memory 12 in a storage step (not shown) at the beginning of the study.

At the first visit by the patient 4 to the study doctor 8 on 1.15,2000, the latter connects the memory 12 i.e. the USB wristwatch to their personal computer 15 as a data input device, and adds to the memory 12 a part of the patient data 16 (see below) specially relating to the patient 4 and relevant to the study 2, in turn illustrated by the arrow 13. The study doctor 8 also enters under date 1.15 the values measured by them for blood pressure, pulse, blood values and overall impression in tabulated form in the patient data 16. They prescribe the patient 4 a dose of 7 mg “ABC” each time (3 times daily at 8/12/16 hours) and also store this value in the memory 12.

At the end of the first study step 10 on 1.15., the study doctor 8 gives the memory 12 to the patient 4. The patient 4 now constantly carries the memory 12 with them as a USB wristwatch for 1 year.

On the 15^{th} of each month, i.e. on 2.15, 3.15 etc. until 12.15, the patient 4 repeats their regular study step 10 prescribed in the study protocol with the study doctor 8. The latter again connects the data memory 12 to their personal computer 15 and adds the current measurement and dose values in the patient data 16. They adapt the dose of “ABC” to the needs of the patient 4 according to the study protocol.

After the last study step 10 on 12.15.2000, the study 2 is ended for the patient 4 and the medicament “ABC” is no longer given to the patient 10. In a concluding step 17, the patient 4 finally gives back the memory 12 to the study doctor 8. The study doctor 8 returns it to the study leader 11.

Example structuring of study- and patient-related data 14, 16 in the memory 12 of a data medium is represented below in a tabulated form:

| Study data: | |
|---|---|
| Clinical study: | Blood pressure reducing formulation |
| Category: | Drug study |
| Beginning: | Jan. 1, 2000 |
| End: | Dec. 31, 2000 |
| Sponsor: | A-Pharma |
| Study leader: | Dr B, Clinic C, Tel 0123-456/ |
| | Mobile 0171-456/Mail B@C.med |
| Active agent: | ABC |
| Dosage: | 3 × 1-10 mg daily, |
| | 8:00/12:00/16:00 hours |
| compatible | DEF, GHI |
| incompatible | JKL, MNO |
| Patient data: | |
| Study doctor | Dr D, Clinic I, B-villle, Tel 0789-123/ |
| | Mail D@I.med |
| Patient: | P, F-street, 90123 D-ville, Tel 0799-567 |
| Age: | 60 |

| | | | Blood | | |
|---|---|---|---|---|---|
| Date | Blood pressure | Pulse | values | Overall impression | Dose |
| 1.15 | 120/80 | 60 | OK | slightly nervous | 7 |
| 2.15 | 140/100 | 70 | Ca high | tired | 5 |
| 3.15 | 130/80 | 55 | OK | good | 3 |
| 4.15 | 160/100 | 50 | K high | tired | 4 |
| . . . | | | | | |
| 12.15 | 130/70 | 50 | OK | good | 0 |

NOTES:
3.30 Food poisoning, given 30 mg GHI Dr H, D-ville, Tel. 0799-234

The data are divided into study data 14 and patient data 16. The data are ordered according to a standardized scheme, which is fixed for all clinical studies. To this end, data fields 18 (first column of the study data) are filled out with information 20 (second column of the study data). All data fields 18 of the study data 14 must be filled out with information 20 at the beginning of the study 2, so that no important information can be forgotten when storing the data on the data medium 12.

The study data 14 are the same for all 500 patients involved in the study, and contain: description, category, beginning, end, sponsor and study leader of the study 2. The study leader is mentioned by name, address and contact details, here landline/mobile telephone and e-mail.

Since the “drug study” category is involved here, the active agent “ABC” administered to all patients, the minimum and maximum dosage and interactions of the active agent with other known active agents are mentioned.

The patient data 16 contain the information relating only to the patient 4 with respect to the study 2 carried out on them. The data fields 18 are personal details of the patient 4 and of the study doctor 8 assigned to them, and the patient's age. Data fields 18 are prepared in tabulated form for all 12 monthly visits by the patient 4 to the study doctor 8, in which the measurement and observation values ordered by date are to be entered monthly as information 20. The patient data 16 furthermore contain an additional data field 18 for entering notes. This is used for the procedure described below:

On 3.30.2000, the patient 4 suffers poisoning by bad food. They require rapid assistance and therefore immediately see their family doctor “H” 22 instead of their study doctor 8. The course of this doctor's visit 23 is represented in FIG. 2. The family doctor 22 is not involved in the study 2 and is not familiar with it, i.e. they are a non-study doctor. They also do not know that their patient 4 is participating in the study 2 and is regularly taking the active agent “ABC”.

In the visit step 24 when the patient 4 comes in contact with the family doctor 22, the patient 4 therefore grants them access to the memory 12 by giving them their USB wristwatch. The family doctor 22 connects it to their laptop 25. As indicated by arrows 27, the family doctor 22 reads the study data 14 and patient data 16 out from the memory 12 in an information step 26 and is a thereby informed of the clinical study 2 being carried out on the patient 4.

The family doctor 22 does not know the active agent “ABC”. The family doctor 22 would normally have administered the active agent “MNO” in a treatment step 28 for the poisoning with which the patient 4 is diagnosed. From the study information 14, however, they know that this is not compatible with the active agent “ABC”. Based on their specialist knowledge, they therefore change to giving the similarly acting active agent “GHI”, which is compatible with “ABC” and has virtually the same effect on the diagnosed poisoning.

The serious health complications due to giving the patient 4 “MNO” are thus prevented. As represented by the arrow 29, the family doctor 22 enters as information 20 the poisoning and the amount of active agent “GHI” administered as information 20 in the “Notes” data field 18 of the patient data 16. They furthermore leave their contact data so that someone responsible for the study has the opportunity to check back with them.

As explained in connection with FIG. 1, after the conclusion of the study 2 the study leader 11 receives all 500 data media with the memories 12 of the patients participating in the study. They now read all the patient data 16 out from the memories 12 and evaluate them. The study leader thereby notes the entry about the poisoning of the patient 4. Since then, it has been established in the scope of the study 2 that although taking “GHI” is harmless for patients treated with “ABC”, it nevertheless increases their blood pressure for approximately 4 weeks. The measurement values of the patient 4 on 4.15 (measured approximately 2 weeks after the poisoning and thus still influenced by taking “GHI”) are therefore not taken into the study database (not shown), but instead declared invalid. The measurement values do not therefore vitiate the study. The quality of the study is increased, since eliminating the measurement value known to be affected by error reduces the spread of the measurement values.

Alternative structuring of study data 14 is shown below in a tabulated form:

Study data:

| | |
|---|---|
| Clinical study: | Blood pressure reducing formulation |
| Category | Drug study |
| Beginning: | Jan. 1, 2000 |
| End: | Dec. 31, 2000 |
| Sponsor: | A-Pharma |
| Study leader: | Dr B, Clinic C, Tel 0123-456/ |
| | mobile 0171-456/Mail B@C.med |
| Medicament: | “M” |
| Dosage: | 3 × 1-10 mg daily, |
| | 8:00/12:00/16:00 hours |
| Instructions: | “M” must not be stopped in any case. |
| | Patient must not be X-rayed on the |
| | upper body. |
| Emerg. (Authoriz.) | “M” |
| | (active agent, compos., interact.) |

Corresponding to the previous example, the study data are again made up of data fields 18 and information 20. In addition, however, the study data 14 are assigned to different confidentiality classes. The information 20 of class 30 (“clinical study” . . . “instructions”) can always be read by all non-study doctors who access the memory 12. These accordingly contain the general data of the study such as contact addresses, duration, subject of the study etc. In contrast to the previous example, instead of the medicament active agent it is now merely mentioned that the medicament administered in the scope of the study is given the code name “M” and must in no event be stopped, and that none of the patients must be X-rayed on the upper body.

The precise information 20 about “M” is assigned to class 32, which contains the active agent and its composition and interactions with other medicaments. At the wish of the sponsor “A-Pharma” of the study 2, however, this information 20 is intended to remain as secret as possible. The corresponding data field 18 is denoted by the keywords “Emergency/Authorization The non-study doctor receives as information only that the information about the active agent, composition and interactions is hidden behind this field. They now have to decide personally whether they absolutely need this information for an interaction with the patient. These data cannot initially be read when the memory 12 is connected to a data reading device 25.

If the patient 4 breaks their leg, for example, this information 20 is unimportant for the treating doctor 22 and they do not need to read them out; they merely pay attention to the instructions which they can read with respect to medicament and X-ray.

In a life-threatening situation for the patient 4 such as a heart attack, for example, the information 20 is however necessary and can then also be read out by the doctor 22. Before or when reading out the information 20 of class 32, the non-study doctor 22 must nevertheless obtain authorization and thereby give an undertaking not to disclose the information 20 which is read.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for carrying out a clinical study involving a patient, comprising:
storing at least one of study-related and patient-related data, to be read out by a non-study doctor assigned to the patient, in a memory during the clinical study.

2. The method as claimed in claim 1, wherein the data are stored in the memory by a study doctor.

3. The method as claimed in claim 1, wherein the non-study doctor reads the data out from the memory before an interaction with the patient.

4. The method as claimed in claim 1, wherein the data are stored in the memory with standardized structuring.

5. The method as claimed in claim 1, wherein clear instructions to the non-study doctor are stored as data.

6. The method as claimed in claim, wherein the data are assigned to various classes, and the non-study doctor reads only information of one class out from the memory.

7. An information system for a clinical study on a patient, having comprising:
a memory assigned to the patient for at least one of study-related and patient-related data;
having a data input device for storing data in the memory; and
a data reading device, accessible by a non-study doctor assigned to the patient, for reading the data out from the memory.

8. The information system as claimed in claim 7, wherein the memory is portable.

9. The information system as claimed in claim 7, wherein the memory is part of a data network, to which data input and output devices are connectable and wherein authorization, is required for access to the data.

10. The information system as claimed in claim 7, wherein the data reading device is portable.

11. The method as claimed in claim 2, wherein the non-study doctor reads the data out from the memory before an interaction with the patient.

12. The method as claimed in claim 2, wherein the data are stored in the memory with standardized structuring.

13. The method as claimed in claim 2, wherein clear instructions to the non-study doctor are stored as data.

14. The method as claimed in claim 2, wherein the data are assigned to various classes, and the non-study doctor reads only information of one class out from the memory.

15. The information system as claimed in claim 8, wherein the data reading device is portable.

16. The information system as claimed in claim 9, wherein the data reading device is portable.

17. An information system for a clinical study on a patient, comprising:
memory means, assigned to the patient, for at least one of study-related and patient-related data;
input means for storing data in the memory means; and
reading means, accessible by a non-study doctor assigned to the patient, for reading the data out from the memory means.

18. The information system as claimed in claim 17, wherein the memory means is portable.

19. The information system as claimed in claim 17, wherein the memory means is part of a data network, to which data input and output devices are connectable and wherein authorization is required for access to the data.

20. The information system as claimed in claim 17, wherein the reading means is portable.
